(19) United States
(12) Patent Application Publication
(10) Pub. No.: US 2026/0139542 A1
(43) Pub. Date: May 21, 2026

(54) SYSTEM AND METHOD FOR STRUCTURAL GLASS FIN PANEL

(71) Applicant: Innovation Glass, LLC, Tivoli, NY (US)

(72) Inventor: Franz Safford, Tivoli, NY (US)

(73) Assignee: Innovation Glass, LLC, Tivoli, NY (US)

(21) Appl. No.: 19/393,804

(22) Filed: Nov. 19, 2025

Related U.S. Application Data
(63) Continuation-in-part of application No. 18/954,732, filed on Nov. 21, 2024.

(51) Int. Cl. E06B 3/64; E06B 3/663; E06B 3/67; E06B 3/673

(52) U.S. Cl. CPC E06B 3/645; E06B 3/66342; E06B 3/67; E06B 3/67313; E06B 3/67326

(57) ABSTRACT

A glass fin wall system configured for attachment to a building structure. The glass fin wall system may comprise an exterior glass pane and an interior glass pane. The interior glass pane may comprise a first end and a second end. The interior glass pane may be oriented parallel to the exterior glass pane. The exterior glass pane may comprise a central portion, a first end bent to create a first bend and a first fin, and a second end bent to create a second bend and second fin. Each of the first and second fins may contain an interior and an exterior surface. The first and second ends of the interior glass pane align generally with the exterior surfaces of the first and second fins. The glass fin wall system may comprise additional interior and exterior glass panes located adjacent the original interior and exterior glass pane.

### CROSS-REFERENCE TO RELATED APPLICATIONS

This application is a continuation in part of U.S. Ser. No. 18/954,732 filed Nov. 21, 2024, titled “SYSTEM AND METHOD FOR STRUCTURAL GLASS FIN PANEL” and incorporates the disclosure of the application by reference. To the extent that the present disclosure conflicts with any referenced application, however, the present disclosure is to be given priority.

### BACKGROUND OF THE TECHNOLOGY

A variety of systems are used in the construction of buildings. Many of these systems employ a framework, such as in the case of conventional point-supported and conventional glass wall systems. In these systems, panes of glass are attached to, and supported by horizontal mullions and vertical mullions. The attachment of glass panels to horizontal and vertical mullions provides challenges due to the aesthetic and performance issues with the finished façade appearance.

### SUMMARY OF THE TECHNOLOGY

A glass fin wall system configured for attachment to a building structure may comprise an exterior glass pane comprising a first end and a second end and an interior glass pane oriented parallel to the exterior glass pane. The interior glass pane may comprise a central portion, a first end bent to create a first bend and a first fin; and a second end bent to create a second bend and second fin. In various

embodiments each of the first and second fins each contain an interior and an exterior surface and the first and second ends of the exterior glass pane align generally with the exterior surfaces of the first and second fins. In various embodiments, additional interior and exterior glass panes may be added to the glass fin wall system.

In various embodiments, the exterior glass pane may be coupled to the interior glass pane by a pair of vertical spacers, which are located inwardly of the interior surface of the first and second fins. The spacers may be oriented vertically and run from an upper edge to a lower edge of the interior and exterior glass panes. The exterior glass pane may be coupled to the interior glass pane by a pair of horizontal spacers. The horizontal spacers run along the upper and lower edges between the first and second fins to create a sealed internal volume. In various embodiments an edge seal may be applied along the length of the pair of horizontal and vertical spacers to create an insulating glass panel.

The glass fin wall system may comprise a sealing element located between the second bend of the interior glass pane, the second end of the exterior glass pane, the first bend of the additional interior glass pane, and the first end of the additional exterior glass pane. The sealing element may comprise an elongate vertical gasket that seals the surfaces of the second bend of the interior glass pane, the second end of the exterior glass pane, the first bend of the additional interior glass pane, and the first end of the additional exterior glass pane.

In various embodiments, the first and second fins on the interior glass pane and the additional interior glass pane each contain an upper aperture and a lower aperture, which are configured to attach the first and second fins on the interior glass pane and to the additional interior glass pane to a pair of upper anchors and lower anchors.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures. For simplicity and clarity of illustration, elements in the figures are not necessarily drawn to scale.

FIG. 1 representatively illustrates a perspective, partial exploded view a structural glass fin panel in accordance with an exemplary embodiment of the present technology;

FIG. 2 representatively illustrates an exploded, perspective view of a structural glass fin panel with partial adjacent structural glass fin panel attached in a horizonal array in accordance with an exemplary embodiment of the present technology;

FIG. 3 representatively illustrates a plan view of a structural glass fin panel with partial adjacent structural glass fin panel attached in a horizonal array in accordance with an exemplary embodiment of the present technology;

FIG. 4 representatively illustrates a detail plan view taken from 4 in FIG. 3 showing the connection of adjacent structural glass fin panels attached in a horizonal array and attachment to an anchor in accordance with an exemplary embodiment of the present technology;

FIG. 5 representatively illustrates a detail plan view take from 5 in FIG. 4 showing the connection of adjacent structural glass fin panels attached in a horizonal array in accordance with an exemplary embodiment of the present technology;

FIG. 6 representatively illustrates a detail plan view taken from 6 in FIG. 4 of an attachment to an anchor in accordance with an exemplary embodiment of the present technology;

FIG. 7 representatively illustrates an exploded view of an attachment mechanism shown in FIG. 6 in accordance with an exemplary embodiment of the present technology;

FIG. 8 representatively illustrates a cross-sectional side of FIG. 1 showing the attachment of the structural glass fin panel to the building structure in accordance with an exemplary embodiment of the present technology;

FIG. 9 representatively illustrates a detail view of 9 in FIG. 8 showing the attachment of the upper portion of the structural glass fin panel to the building structure in accordance with an exemplary embodiment of the present technology;

FIG. 10 representatively illustrates a detail view of 10 in FIG. 8 showing the attachment of the lower portion of the structural glass fin panel to the building structure in accordance with an exemplary embodiment of the present technology;

FIG. 11 representatively illustrates a side view showing the attachment of the structural glass fin panel to the building structure in accordance with an exemplary embodiment of the present technology;

FIG. 12 representatively illustrates a side view showing the attachment of the structural glass fin panel to the building structure in accordance with an exemplary embodiment of the present technology;

FIG. 13 representatively illustrates a side view showing the attachment of the structural glass fin panel to the building structure in accordance with an exemplary embodiment of the present technology;

FIG. 14 representatively illustrates a perspective, partial exploded view a structural glass fin panel in accordance with an additional exemplary embodiment of the present technology;

FIG. 15 representatively illustrates an exploded, perspective view of a structural glass fin panel with partial adjacent structural glass fin panel attached in a horizonal array in accordance with an additional exemplary embodiment of the present technology;

FIG. 16 representatively illustrates a plan view of a structural glass fin panel with partial adjacent structural glass fin panel attached in a horizonal array in accordance with an additional exemplary embodiment of the present technology;

FIG. 17 representatively illustrates a detail plan view taken from 17 in FIG. 16 showing the connection of adjacent structural glass fin panels attached in a horizonal array and attachment to an anchor in accordance with an exemplary embodiment of the present technology; and

FIG. 18 representatively illustrates a cross-sectional side of FIG. 14 showing the attachment of the structural glass fin panel to the building structure in accordance with an exemplary embodiment of the present technology.

### DETAILED DESCRIPTION OF THE DRAWINGS

The present technology may be described in terms of functional block components and various processing steps. Such functional blocks may be realized by any number of components configured to perform the specified functions and achieve the various results. For example, the present technology may employ various types of curtain wall systems, walls, anchors, bars, plates, glass panels, glass panes, glass fins, sealing materials, fittings, hangers, fasteners, spacers, walls, and the like, which may carry out a variety of functions. Further, the present technology may employ any number of components for a construction system utilized to support glass panels or panes.

A glass wall system, also known as a panelized window wall system, is a type of architectural feature commonly used in modern building design. Typically, a glass wall system is a non-structural exterior building envelope designed to keep out the weather and create a barrier between the interior and exterior of a building. A glass wall system employs certain structural attributes that resist applied loads (wind) and to support itself but generally does not contribute to the structural integrity of the building itself. The glass wall system may allow natural light to enter the building and provide occupants with views of the surroundings. The glass panels used in glass wall systems are often double-glazed for insulation and energy efficiency.

A glass wall system may also distribute loads and resist wind pressure and other environmental forces. The glass wall system may utilize various seals and gaskets, which are integrated into the curtain wall system to prevent water, air, and other environmental elements from entering the building. These elements maintain the building's integrity and ensure a comfortable interior environment. The glass wall system may also be configured to mount to the building structure utilizing various types of attachment mechanisms, such as anchors, fittings and the like.

Glass wall systems are desired in the construction and architectural industry for their sleek and minimalist appearance. They create a transparent or semi-transparent barrier that allows natural light to penetrate interior spaces of buildings and provide a sense of openness and connection with the surrounding environment. Glass wall systems may also provide thermal insulation and reduce heat transfer enhance to the energy efficiency of the building. Additionally, glass wall systems may be designed to offer acoustic insulation, helping to reduce noise transmission from the exterior to the interior or vice versa.

Glass wall systems offer a high degree of customization in terms of size and shape. This allows architects and designers to create unique and visually striking building facades. As such, glass wall systems are commonly used in commercial buildings, office spaces, retail centers, and even residential architecture. They are often featured in contemporary and modern architectural designs where transparency, aesthetics, and functionality are important considerations.

Various representative implementations of the present technology may be applied to any system for construction. Certain representative implementations may include systems and methods tailored to a specific type of construction.

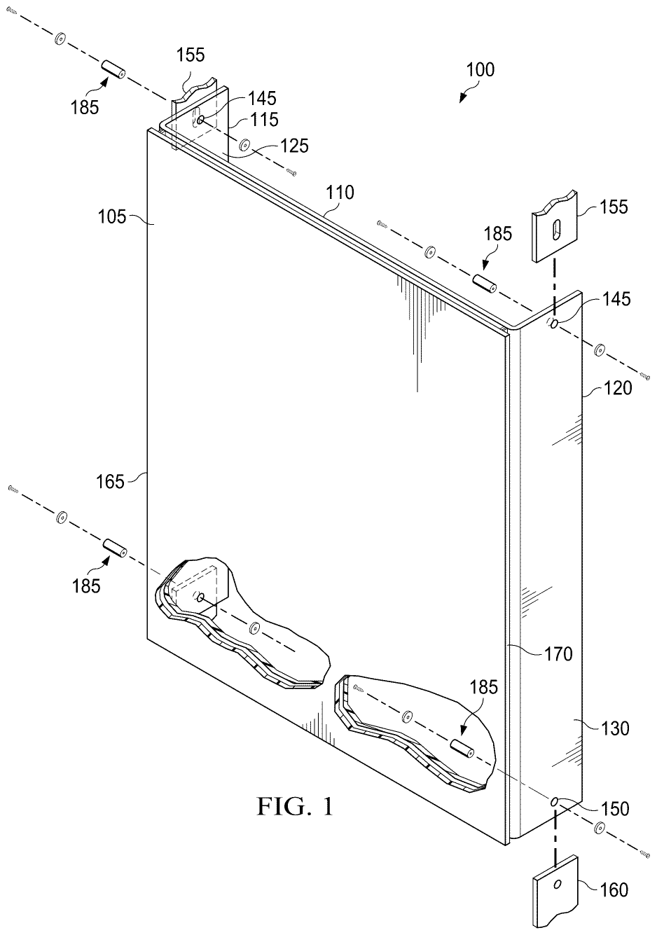

Referring now to FIGS. 1-3, a glass wall system 100 generally comprises an exterior glass pane 105 and an interior glass pane 110.

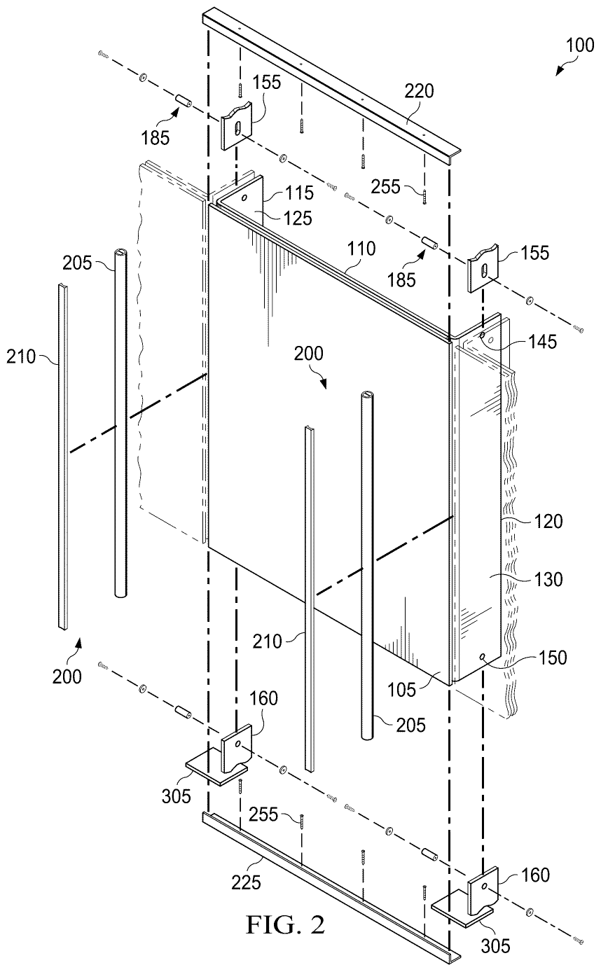

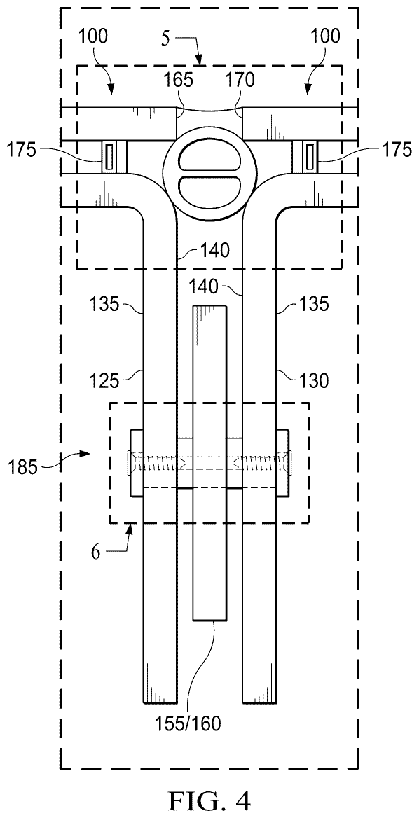

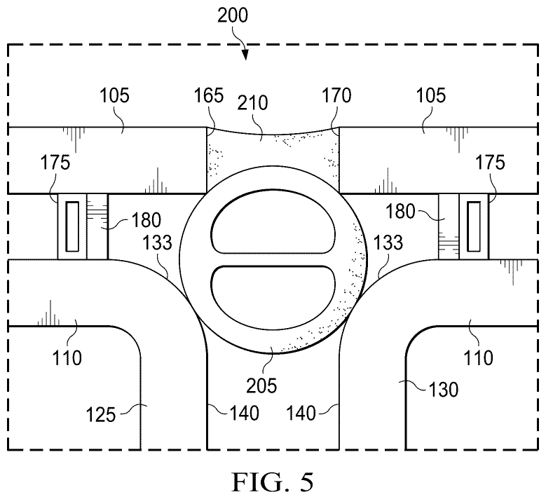

The interior glass pane 110 may comprise a central portion and a first end 115 and second end 120, each of which may be bent at substantially a 90 degree angle to create a first fin 125 and second fin 130. The interior glass pane 110 may be hot bent to create the first and second fins 125, 130 and a corner or bend 133 (FIG. 5). The interior glass pane 110 may be heat treated to reach a fully tempered state. As shown in FIG. 4, the first and second fins 125, 130 each contain an interior surface 135 and an exterior surface 140. Referring again to FIGS. 1 and 2, the first and second fins 125, 135 each contain an upper aperture 145 and a lower aperture 150, which are configured to attach the first and second fins 125, 135 to a pair of upper anchors 155 and lower anchors 160.

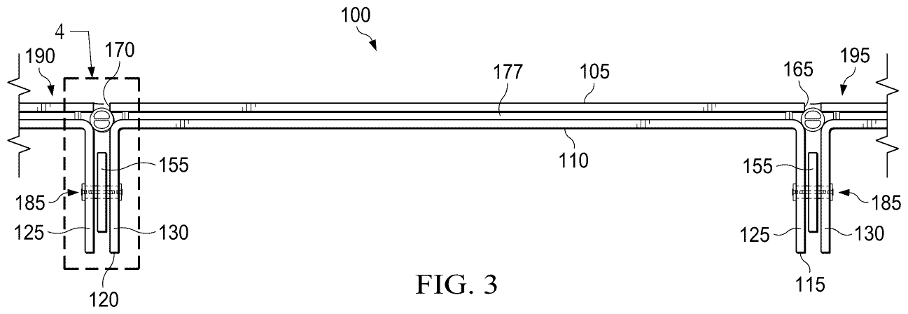

Referring to FIGS. 3 and 4, the exterior glass pane 105 may comprise a first end 165 and a second end 170. The first and second ends 165, 170 of the exterior glass pane 105 align generally with the exterior surfaces 140 of the first and second fins 125, 130.

As shown in FIGS. 4 and 5, the exterior glass pane 105 may be coupled to the interior glass pane 110 by a pair of spacers 175, which are located inwardly of the interior surface 135 of the first and second fins 125, 130. The spacers 175 are oriented vertically and run from the upper edge to the lower edge of the interior and exterior glass panes 110, 105 and horizontally and run along the upper and lower edges between the first and second fins 125, 130 creating a sealed internal volume (See FIGS. 4, 5, 9, and 10). Once the spacers 175 are installed or in conjunction therewith, an edge structural silicon seal 180 may be applied along the length of the spacer 175 and on the internal surfaces of the interior and exterior glass panes 110, 105 to create an insulating glass panel. The vertical and horizontal spacers 175 can be single or multiple pieces.

As shown in FIGS. 1 and 3, the glass wall system 100 may be coupled to a building structure (not shown) utilizing a pair of upper anchors 155 and lower anchors 160.

The glass wall system 100 may be coupled to each upper anchor 155 and each lower anchor 160 by a pin assembly 185. In practical applications multiple glass wall systems 100 are coupled thereto in horizontal and vertical arrays in various configurations. FIG. 1 shows an individual glass wall system 100. FIGS. 2 and 3 show a glass wall system 100 and 2 portions of adjacent glass wall systems 100 coupled together in a horizontal array to form a glass wall.

FIG. 3 shows a center glass wall system 100, a partial, left glass wall system 190 and, a partial, right glass wall system 195. The first fin 125 of the center wall system 100 may be coupled to the second fin 130 of the partial, right glass wall system 195 and the upper anchor 155 and lower anchor 160 (not shown) by a pair of pin assemblies 185. The second fin 130 of the center wall system 100 may be coupled to the first fin 125 of the partial, left glass wall system and the upper anchor 155 and lower anchor 160 (not shown) by another pair of pin assemblies 185.

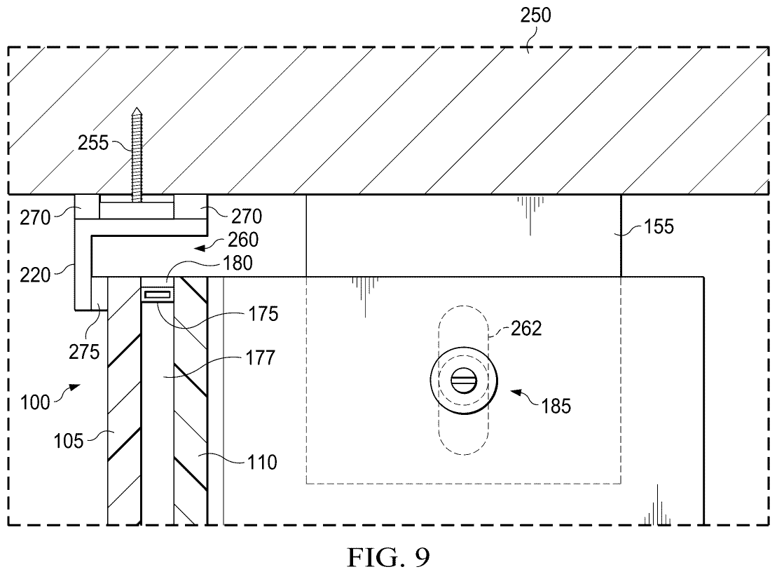

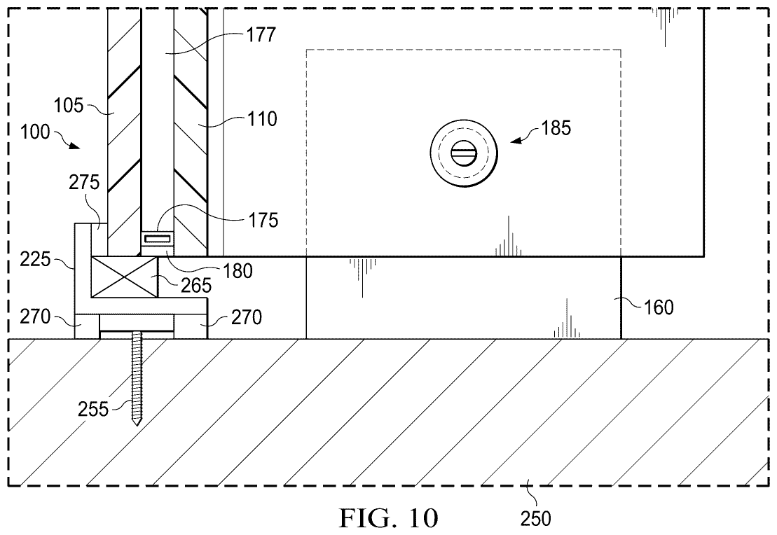

FIG. 4 shows the pin assembly connecting adjacent glass wall systems 100 connected to an upper or lower anchor 155, 160. Once the adjacent glass wall systems 100 are connected, they are sealed together to protect the system from external elements. Referring now to FIGS. 2 and 5, a sealing element 200 may be placed between the bends 133 and the first and second ends 165, 170 of the exterior glass pane 105. The sealing element 200 may comprise an elongated vertical oriented gasket 205 and exterior silicone seal 210, which may comprise any suitable sealant material, including but not limited to silicone, silicon elastomer and the like. The sealing element 200 may comprise edge structural seals 180, which are located adjacent the spacers 175 on the internal surfaces of the interior and exterior glass panes 110, 105 both horizontally (FIGS. 9 and 10) and vertically (FIG. 5). This configuration provides an airtight construction or a sealed, void area 177 which eliminates any foreign element from penetrating the adjacent glass wall systems 100. Upper and lower metal angles 220, 225 may then be attached to the upper and lower edges of the assembled wall system to seal the interior and exterior glass panes 110, 105 to the building structure.

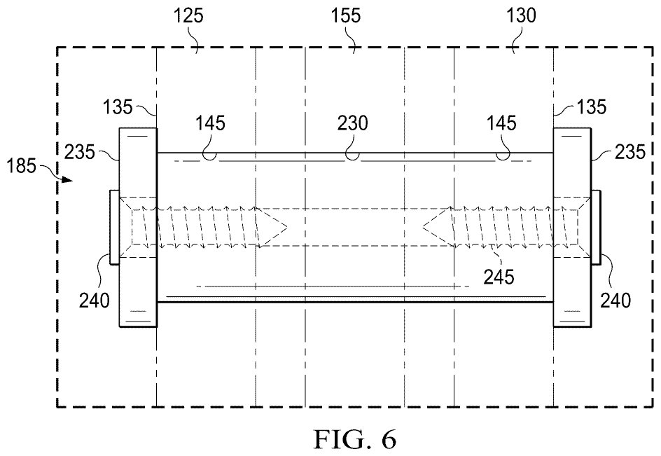

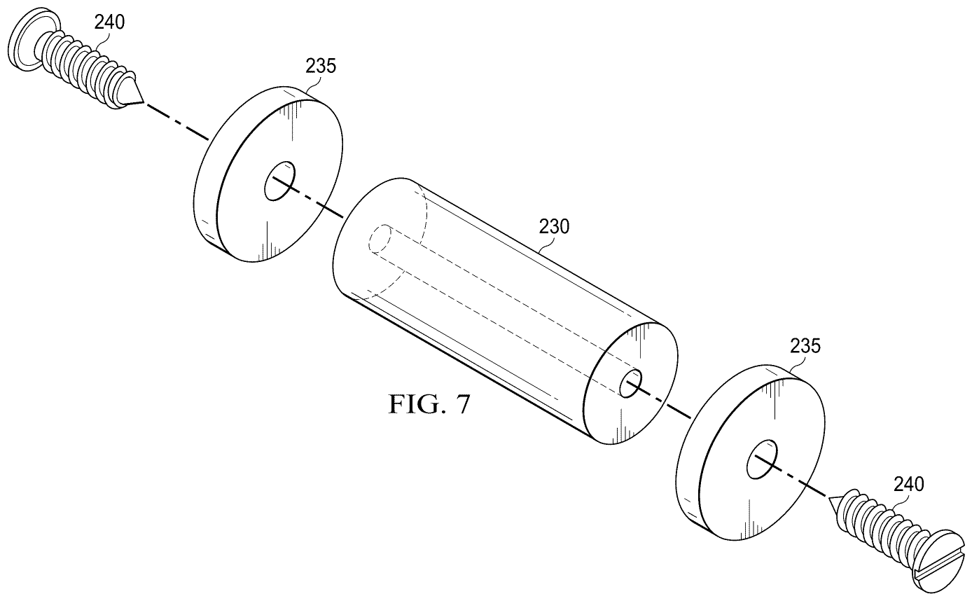

Referring now to FIGS. 6 and 7, the pin assembly 185 may comprise a central collar 230, a pair of washers 235, and a pair of fasteners 240. For the purpose of this discussion, FIG. 6 shows the pin assembly 185 coupling the first fin 125 of the glass wall system 100 to the second fin 130 of an adjacent glass wall system 100 and the upper anchor 155. The collar 230 may be received within the upper apertures 145, the washers 235 are placed on the interior surface 135, and the fasteners 240 are received within a threaded bore 245 of the central collar 230. A nut and bolt or any other suitable fastening configuration may be contemplated.

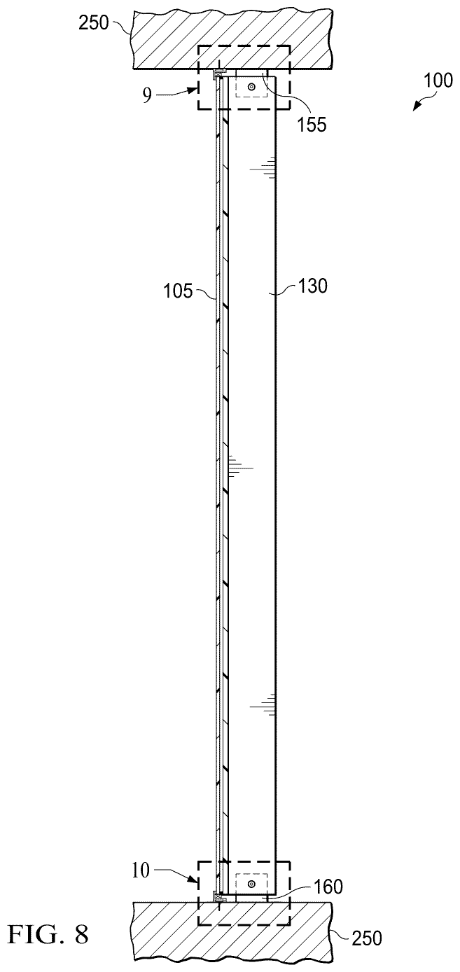

Referring now to FIG. 8, the glass wall system 100 is shown attached to a building structure. The upper and lower anchors 155, 160 extend from the building structure comprising a floor slab 250. Referring to FIGS. 9 and 10, the specific connection of the glass wall system 100 to the floor slab 250 will be discussed. As discussed above, the pin assembly 185 may be used to couple the glass wall system to the upper and lower anchors 155, 160. During installation the upper and lower metal angles 220, 225 may then be attached to the upper and lower edges of the assembled wall system to seal the interior and exterior glass panes 110, 105 and to the floor slabs 250 by fasteners 255. Lower silicone support block 265 is placed between the lower edge of the exterior glass pane 105 to support the glass pane 105 in relationship to the lower metal angle, 225. A space 260 resides between the upper edges of the exterior glass pane 105 and the upper metal angle 220 to allow for adjustment of the pin assembly 185 in the upper anchor 155. The upper anchor 155 may comprise an elongate aperture 262 to allow for vertical adjustment of the pin 185 within the upper anchor 155 during installation but is also there to accommodate movement from the building structure and/or building slab 250. Various other elastomeric sealing elements are also placed adjacent to the exterior glass pane 105, the upper and lower metal angles 220, 225 and the floor slab to seal and protect the glass wall system 100. In various embodiments, at least one sealing element 270 may be placed between the upper and lower metal angles 220, 225 and the floor slab 250. In various embodiments, an additional sealing element 275 may be placed between the upper and lower metal angles 220, 225 and the exterior glass pane 105.

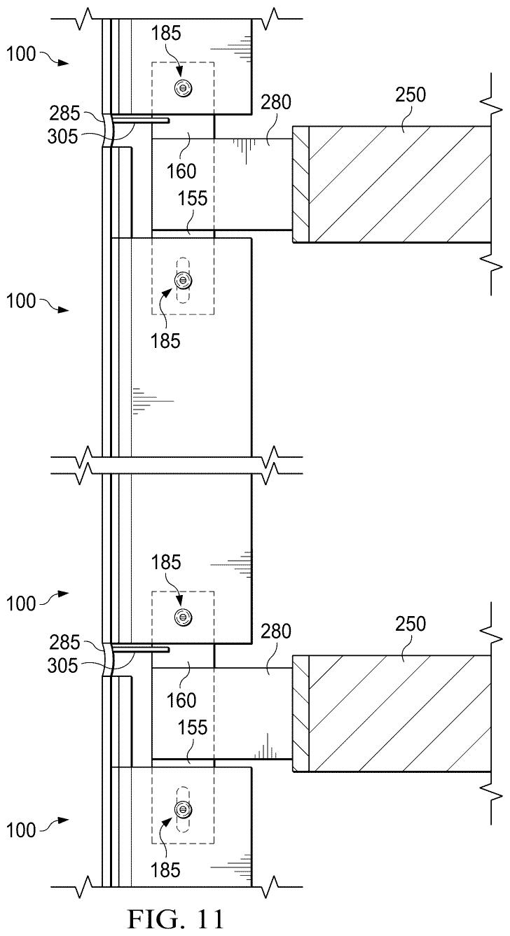

FIGS. 11-13 show various embodiments of the glass wall system 100 being coupled to various building structures, including anchor plates and floor slabs. FIG. 11 shows a glass wall system 100 and 2 partial glass wall systems 100 located above and below in a vertical array. The glass wall systems 100 are coupled to anchor plates 280 extending from floor slabs 250. The upper and lower anchors 155, 160 extend from the anchor plates 280, and are connected to the glass wall systems 100 by the pin assembly 185. A gravity shelf plate 305 on FIGS. 2 and 11 may be attached to lower anchor 160 to support the self-weight the glass wall system 100. The gravity shelf plate 305 may be welded or otherwise coupled to the lower anchor 160. To seal the glass wall system 100 and 2 partial glass wall systems 100, a silicone seal 285 may be installed to protect the glass wall system 100 from the external elements.

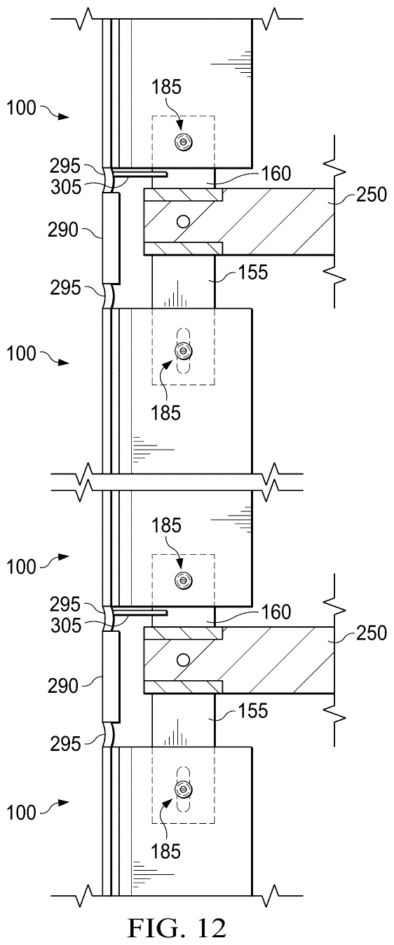

FIG. 12 shows a glass wall system 100 and 2 partial glass wall systems 100 located above and below in a vertical array. The glass wall systems 100 are coupled to the upper and lower anchors 155, 160 extending from floor slabs 250 and are connected to the glass wall systems 100 by the pin assembly 185. The gravity shelf plate 305 on FIG. 12 is attached to upper anchor 160 to support the self-weight of glass wall system 100. To seal the glass wall system 100 and 2 partial glass wall systems 100, metal plate 290 may be installed with a pair of silicone seals 295 to protect the glass wall system 100 from the external elements.

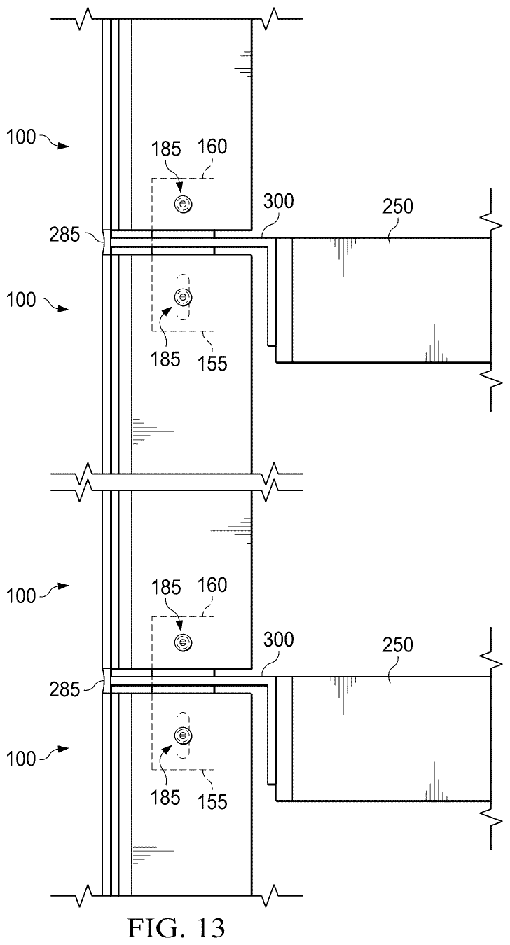

FIG. 13 shows a glass wall system 100 and 2 partial glass wall systems 100 located above and below in a vertical array. The glass wall systems 100 may be coupled to L-shaped anchor plates 300 extending from floor slabs 250. The upper and lower anchors 155, 160 may extend from the L-shaped anchor plates 300 and are connected to the glass wall systems 100 by the pin assembly 185. The self-weight of the glass wall system 100 may be supported by anchor plates 300. To seal the glass wall system 100 and 2 partial glass wall systems 100, silicone seal 285 may be installed to protect the glass wall system 100 from the external elements.

### New Portion

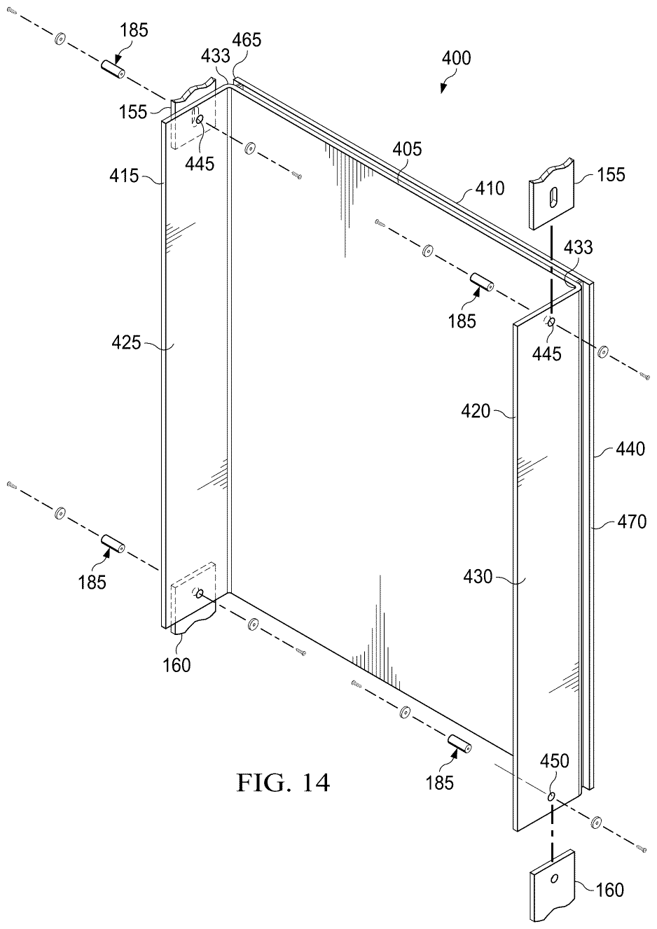

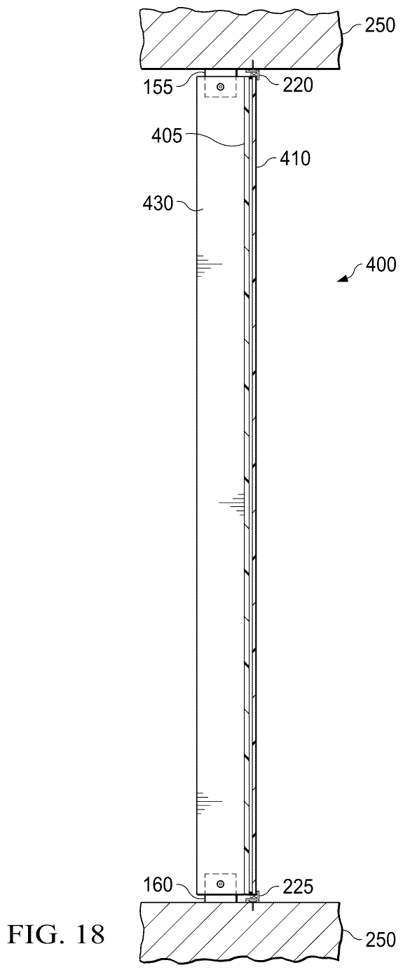

Referring now to FIGS. 14-18 an additional embodiment of a glass wall system 400 generally comprises an exterior glass pane 405 and an interior glass pane 410. The glass wall system 400 is similar to the glass wall system 100 with the exception that the exterior glass pane 405 is used to create the first and second fins, rather than the interior glass pane 410.

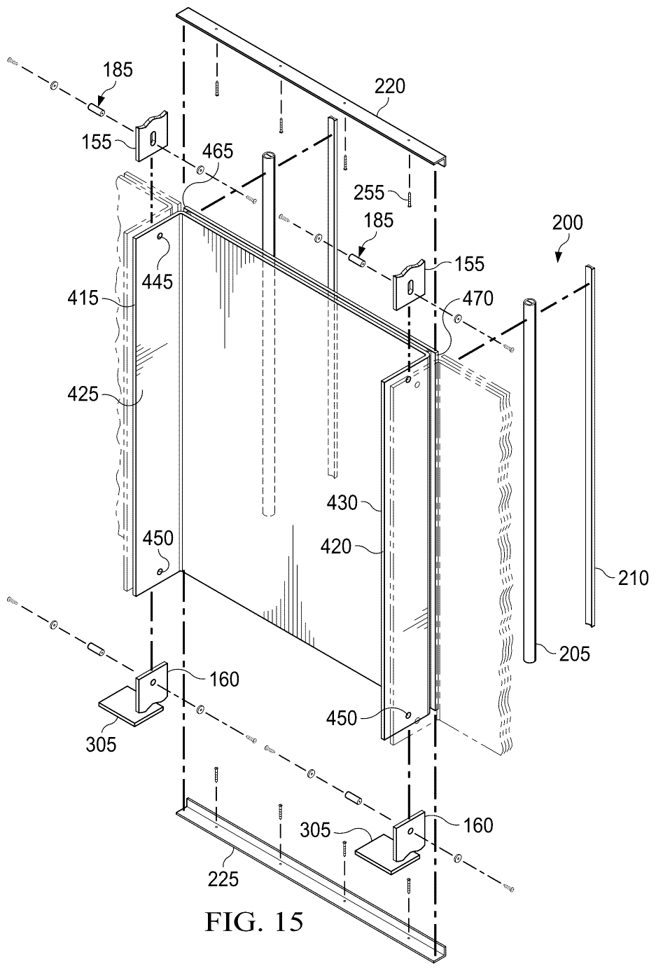

The exterior glass pane 405 may comprise a central portion and a first end 415 and second end 420, each of which may be bent at substantially a 90 degree angle to create a first fin 425 and second fin 430. The exterior glass pane 405 may be hot bent to create the first and second fins 425, 430 and a corner or bend 433. The exterior glass pane 405 may be heat treated to reach a fully tempered state. As shown in FIG. 4, the first and second fins 425, 430 each contain an interior surface 435 and an exterior surface 440. Referring again to FIGS. 14 and 15, the first and second fins 425, 435 each contain an upper aperture 445 and a lower aperture 450, which are configured to attach the first and second fins 425, 435 to a pair of upper anchors 155 and lower anchors 160.

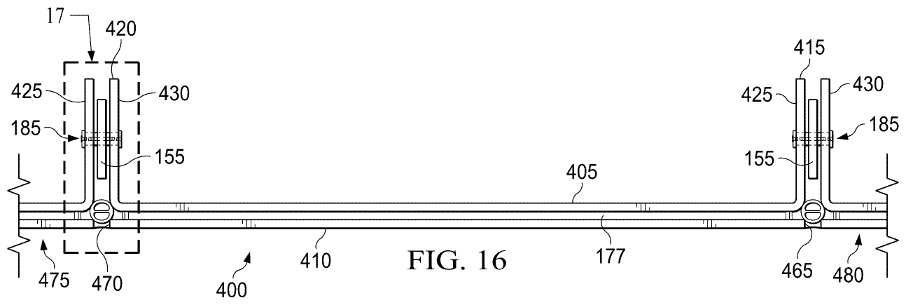

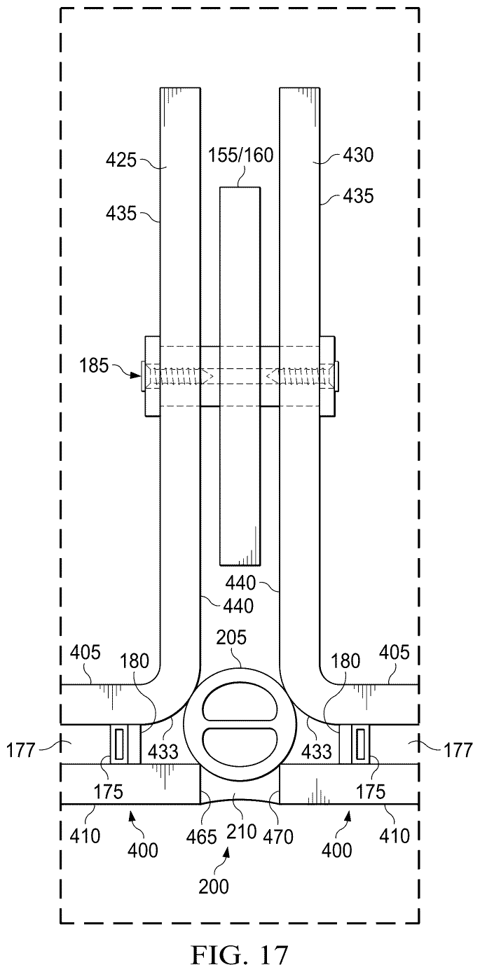

Referring to FIGS. 16 and 17, the interior glass pane 410 may comprise a first end 465 and a second end 470. The first and second ends 465, 470 of the interior glass pane 410 align generally with the exterior surfaces 440 of the first and second fins 425, 430.

As shown in FIG. 17, the exterior glass pane 405 may be coupled to the interior glass pane 410 by a pair of spacers 175, which are located inwardly of the interior surface 435 of the first and second fins 425, 430. The spacers 175 are oriented vertically and run from the upper edge to the lower edge of the interior and exterior glass panes 410, 405 and horizontally and run along the upper and lower edges between the first and second fins 425, 430 creating a sealed internal volume (See FIGS. 16 and 17). Once the spacers 175 are installed or in conjunction therewith, an edge structural silicon seal 180 may be applied along the length of the spacer 175 and on the internal surfaces of the interior and exterior glass panes 410, 405 to create an insulating glass panel. The vertical and horizontal spacers 175 can be single or multiple pieces.

As shown in FIGS. 14, 16 and 18, the glass wall system 400 may be coupled to a building structure (not shown) utilizing the pair of upper anchors 155 and lower anchors 160.

The glass wall system 400 may be coupled to each upper anchor 155 and each lower anchor 160 by a pin assembly 185. In practical applications multiple glass wall systems 100 are coupled thereto in horizontal and vertical arrays in various configurations. FIG. 14 shows an individual glass wall system 400. FIGS. 15 and 16 show a glass wall system 400 and 2 portions of adjacent glass wall systems 400 coupled together in a horizontal array to form a glass wall.

FIG. 16 shows a center glass wall system 400, a partial, left glass wall system 475 and, a partial, right glass wall system 480. The first fin 425 of the center wall system 400 may be coupled to the second fin 430 of the partial, right glass wall system 480 and the upper anchor 155 and lower anchor 160 (not shown) by a pair of pin assemblies 185. The second fin 430 of the center wall system 400 may be coupled to the first fin 425 of the partial, left glass wall system 475 and the upper anchor 155 and lower anchor 160 (not shown) by another pair of pin assemblies 185.

FIG. 17 shows the pin assembly 185 connecting adjacent glass wall systems 400 connected to an upper or lower anchor 155, 160. Once the adjacent glass wall systems 400 are connected, they are sealed together to protect the system from external elements. Referring now to FIGS. 15-17, the sealing element 200 may be placed between the bends 433 and the first and second ends 465, 470 of the interior glass pane 410. The sealing element 200 may comprise an elongated vertical oriented gasket 205 and exterior silicone seal 210, which may comprise any suitable sealant material, including but not limited to silicone, silicon elastomer and the like. The sealing element 200 may comprise edge structural seals 180, which are located adjacent the spacers 175 on the internal surfaces of the interior and exterior glass panes 410, 405 both horizontally (FIGS. 9 and 10) and vertically (FIG. 5). While not shown in FIGS. 16 and 17 it is understood that the same spacers 175 and orientation thereof may be used in each embodiment. This configuration provides an airtight construction or a sealed, void area 177 which eliminates any foreign element from penetrating the adjacent glass wall systems 100. Upper and lower metal angles 220, 225 may then be attached to the upper and lower edges of the assembled wall system to seal the interior and exterior glass panes 410, 405 to the building structure.

In a construction system according to various aspects of the present technology, mullions may be attached to the structure of a building to provide a framework for supporting construction sections. The construction system may also be used to achieve various aesthetic benefits. For example, the panes of glass used to form a glass wall will generally be displaced away from the mullions, making it more difficult to see the mullions from an exteriorly disposed vantage point. Additionally, construction systems in accordance with the present technology may be used to achieve any structural benefit, whether now known or hereafter described in the art, such as the ability to construct a multi-story point-supported glass wall system using substantially vertically-aligned mullions without the need for horizontally-aligned mullions. The key attribute of this technology is that glass wall system 100 is completely transparent with no metal structure in the vision plane.

Constructs (i.e., construction designs) that may be realized via implementation of various embodiments of the present technology shall be understood to comprise anything that may be at least partially assembled from at least one or more component parts, such as, for example: a window; a wall; a partition; a frame; a panel; a covering; a dome; a door; a display case; a display wall; a display frame; a cubicle; a presentation display; a booth; an enclosure; a temporary habitat; a mobile home; a video device array; various architectural construction elements; and/or the like.

A ‘construction section’ shall be understood to comprise any component part of a construct surface, such as, for example, a pane of glass, a panel of wood, a sheet of drywall, a graphite board, Plexiglas, Lucite, a video device element, etc. Furthermore, a construction section may comprise any two-dimensional (e.g., substantially planar) or three-dimensional (e.g., polyhedral, spherical, hemispherical, elliptical, parabolic, etc.) geometry and/or any combination thereof.

In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to an exemplary embodiment. However, changes and modifications may be made to the exemplary embodiment without departing from the scope of the present technology. These and other changes or modifications are intended to be included within the scope of the present technology.

1. A glass fin wall system configured for attachment to a building structure, comprising:
an interior glass pane comprising a first end and a second end; and
an exterior glass pane oriented parallel to the interior glass pane, comprising:
a central portion;
a first end bent to create a first bend and a first fin; and
a second end bent to create a second bend and second fin; wherein each of the first and second fins each contain an interior and an exterior surface, and wherein the first and second ends of the interior glass pane align generally with the exterior surfaces of the first and second fins.

2. The glass fin wall system of claim 1, further comprising:
an additional interior glass pane comprising a first end and a second end; and
an additional exterior glass pane oriented parallel to the additional interior glass pane, comprising:
a first end bent to create a first bend and a first fin on the additional exterior glass pane; and
a second end bent to create second bend and a second fin on the additional exterior glass pane; wherein each of the first and second fins on the additional exterior glass pane each contain an interior and an exterior surface, and wherein the first and second ends of the additional interior glass pane align generally with the exterior surfaces of the first and second fins on the additional exterior glass pane.

3. The glass fin wall system of claim 2, wherein the exterior glass pane may be coupled to the interior glass pane by a pair of vertical spacers, which are located inwardly of the interior surface of the first and second fins.

4. The glass fin wall system of claim 3, wherein the spacers are oriented vertically and run from an upper edge to a lower edge of the interior and exterior glass panes.

5. The glass fin wall system of claim 4, wherein the exterior glass pane may be coupled to the interior glass pane by a pair of horizontal spacers.

6. The glass fin wall system of claim 5, wherein the horizontal spacers run along the upper and lower edges between the first and second fins to create a sealed internal volume.

7. The glass fin wall system of claim 6, wherein an edge seal is applied along the length of the pair of horizontal and vertical spacers to create an insulating glass panel.

8. The glass fin wall system of claim 4, further comprising a sealing element located between the second bend of the exterior glass pane, the second end of the interior glass pane, the first bend of the additional exterior glass pane, and the first end of the additional interior glass pane.

9. The glass fin wall system of claim 8, wherein the sealing element comprises an elongate vertical gasket that seals the surfaces of the second bend of the exterior glass pane, the second end of the interior glass pane, the first bend of the additional exterior glass pane, and the first end of the additional interior glass pane.

10. The glass fin wall system of claim 9, wherein the sealing element is located adjected to the vertical spacers.

11. The glass fin wall system of claim 1, wherein the first and second bends are at approximately 90 degrees.

12. The glass fin wall system of claim 2, wherein the first and second fins on the exterior glass pane and the additional exterior glass pane each contain an upper aperture and a lower aperture, which are configured to attach the first and second fins on the exterior glass pane and to the additional exterior glass pane to a pair of upper anchors and lower anchors.

13. The glass fin wall system of claim 12, wherein each of the first and second fins on the exterior glass pane and the additional exterior glass pane are coupled to the pair of upper anchors and lower anchors by a pin assembly.

14. The glass fin wall system of claim 13, wherein the upper and lower anchors are coupled to the building structure.

15. The glass fin wall system of claim 13, wherein the pin assembly is received in the upper and lower apertures to couple the first and second fins on the exterior glass pane and the additional exterior glass pane to the pair of upper anchors and lower anchors to couple the glass fin wall system to the building structure.

16. A glass fin wall system configured for attachment to a building structure, comprising:
an interior glass pane comprising a first end and a second end; and
an exterior glass pane oriented parallel to the interior glass pane, comprising:
a central portion;
a first end bent to create a first bend and a first fin;
a second end bent to create a second bend and second fin; wherein each of the first and second fins each contain an interior and an exterior surface, and wherein the first and second ends of the interior glass pane align generally with the exterior surfaces of the first and second fins;
an additional interior glass pane comprising a first end and a second end; and
an additional exterior glass pane oriented parallel to the additional interior glass pane, comprising:
a first end bent to create a first bend and a first fin on the additional exterior glass pane; and
a second end bent to create second bend and a second fin on the additional exterior glass pane; wherein each of the first and second fins on the additional exterior glass pane each contain an interior and an exterior surface, and wherein the first and second ends of the additional interior glass pane align generally with the exterior surfaces of the first and second fins on the additional exterior glass pane.

17. The glass fin wall system of claim 16, wherein the first and second fins on the exterior glass pane and the additional exterior glass pane each contain an upper aperture and a lower aperture, which are configured to attach the first and second fins on the exterior glass pane and to the additional exterior glass pane to a pair of upper anchors and lower anchors.

18. The glass fin wall system of claim 17, wherein each of the first and second fins on the exterior glass pane and the additional exterior glass pane are coupled to the pair of upper anchors and lower anchors by a pin assembly, and wherein the upper and lower anchors are coupled to the building structure.

19. The glass fin wall system of claim 18, wherein the exterior glass pane may be coupled to the interior glass pane by a pair of vertical spacers and horizontal spacers, which are located inwardly of the interior surface of the first and second fins.

20. The glass fin wall system of claim 19, wherein the vertical spacers are oriented vertically and run from an upper edge to a lower edge of the interior and exterior glass panes and wherein the horizontal spacers run along the upper and lower edges between the first and second fins to create a sealed internal volume.
